(19) United States
(12) Patent Application Publication
(10) Pub. No.: US 2008/0111264 A1
(43) Pub. Date: May 15, 2008

(54) Vibration Based Injection Molding Machine Damage Detection and Health Monitoring

(75) Inventor: Brian ESSER, Colchester, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/559,944

(22) Filed: Nov. 15, 2006

(51) Int. Cl. B29C 45/76

(52) U.S. Cl. 264/40.1; 425/169; 73/865.9

(57) ABSTRACT

A system and method for evaluating the structural integrity of an injection molding machine and/or a component thereof may comprise at least one sensor operatively connected to a component of the injection molding machine. The sensor may transmit a signal representative of the movement of the injection molding machine. A processor may convert this signal into a frequency domain signal and compare it against a frequency template. Changes to the structural integrity of the injection molding machine may result in changes to the system's frequency response spectrum such as, but not limited to, amplification of certain frequency peaks, amplitude variations, changes in the damping characteristics, the shifting of the fundamental mode (i.e., the first natural frequency), shifting of higher order modes (those above the fundamental mode), or the introduction of a new frequency mode of vibration that did not exist prior to the damage of the component.

### TECHNICAL FIELD

The present disclosure relates to molding systems and more particularly, relates to systems and methods for detecting damage of a component of an injection molding system.

### BACKGROUND INFORMATION

Injection molding machines such as, but not limited to, hot runner injection molding machine manufactured by Husky Injection Molding Systems Ltd., are typically subjected to very high levels of cyclic stress, shock, and vibration due to the nature of the injection molding process. As the injection molding process continues to develop and evolve, future injection molding machines will likely utilize faster injection times, thinner wall components, new materials with poorly understood failure characteristics, and higher injection pressures. This cyclic loading, shock, and vibration of the components of the injection molding machine at high stress levels causes fatigue over time which, if undetected, can result in cracking, fracture, bending, or other damage within the injection molding machine. In some cases, catastrophic system failure of the injection molding machine can occur.

The leakage of molten plastics or resin material outside of the designed melt path has many undesirable effects. For example, the leaking plastic from a cracked manifold can fill a significant portion of the internal voids of the injection molding machine and damage or contaminate multiple components in the injection molding machine, such as, but not limited to, heaters, wires, terminals, insulation, as well as other parts or components. The cost of spare parts, labor to clean, repair, and/or inspect the injection molding machine, and the loss of productivity of the injection molding machine during repair can be very high and unsatisfactory to the end users.

There have been previous attempts to deal with these problems. For example, one approach as described in the abstract of U.S. Pat. No. 5,542,835, includes a leak detector for a plastics injection molding machine that comprises a small diameter conduit (20) located adjacent to a potential leak site on or associated with the machine, through which a regulated supply of air is emitted. When the conduit outlet (26) is blocked with leaked molten plastics, a sensor (45) in the conduit instantly detects a change in air flow or back pressure and triggers an alarm (65), and optionally cuts off the machine automatically to avoid damage to machine components and with the object of reducing machine down time. Changes in incoming primary air supply pressure may be detected to provide a fail-safe system. Alternatively, air pressure in the conduit (20) may be below zero, i.e. a vacuum, so that air is sucked into the conduit at its outlet (26). Several potential leak sites may be monitored simultaneously from a single sensor arrangement.

Another approach, as described in the Abstract of U.S. Pat. No. 4,921,416, includes an injection molding machine having a system for detecting nozzle leaks including a thermocouple positioned in the tunnel opening of a stationary platen of the machine at a predetermined location relative to the nozzle to sense instantaneous temperature at the location. A controller coupled to the thermocouple receives signals from the thermocouple and activates an alarm when the temperature in the tunnel opening falls outside of a predetermined normal operating temperature range.

It is important to note that the present disclosure is not intended to be limited to a system or method which must satisfy one or more of any stated or implied objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

According to one embodiment, the present disclosure features a detection system comprising an injection molding machine, one or more sensors operatively coupled to the injection molding machine and configured to transmit a signal representative of a movement of the injection molding machine, and a processor configured to convert the signal into a frequency domain signal and compare the frequency domain signal against a frequency template to determine the presence of potential structural damage to the injection molding machine. The sensor may comprise an accelerometer, a displacement transducer, a velocity transducer, and/or a force transducer.

The processor may further comprise memory for storing the frequency template. Acceptable frequency domain operation window values may be stored in the memory and used by the processor to disregard frequencies that exceed the acceptable frequency domain operation window values. The detection system may additionally include an amplifier configured to amplify the signal transmitted by the sensor, a filter configured to filter the signal transmitted by the sensor, and an analog-to-digital converter configured to convert the signal from an analog signal to a digital signal which may be transmitted to the processor.

According to another embodiment, the present disclosure features a method of evaluating a structural integrity of a molding injection machine. A frequency domain signal representative of a movement of the injection molding machine may be generated and compared against one or more frequency templates. The frequency templates may be static (substantially unchanging) or dynamic (changing due to changes in part size, clamp tonnage, resin type, mold temperature, known part wear, or the like) and may be used to detect both long term (for example, over the life of the injection molding machine) and short term (for example, cycle to cycle, day to day, month to month, etc.) changes in the injection molding machine's structural dynamics. An alarm condition representative of a possible structural integrity issue may be generated when the signal is outside its normal, acceptable range of operation.

Optionally, an operator may be notified in the event of possible structural damage to the injection molding machine. An alarm signal may be transmitted to an injection molding machine controller. The alarm condition may be classified as either a low priority condition or a high priority condition. In the event of a low priority condition, a maintenance event may be automatically or manually scheduled. In the event of a high priority condition, the injection molding machine may be automatically or manually shut down.

For example, a low priority classification may be used for conditions when something has changed significantly enough to cause operation outside of the acceptable window, though the exact cause may not be known. On the other hand, a high priority condition may (for example) include a condition which is understood well enough that the software may determine the source of the change (for example, but not limited to, a crack beginning in the lower operator side corner of the manifold, drop xx, or the like). This knowledge may be obtained through experimentation. Lack of this knowledge in this regard, however, does not limit the capabilities of the system in terms of noticing changes, though it may make the determination of the exact cause of the change more difficult.

According to yet another embodiment, the present disclosure features a detection system comprising an injection molding machine, a sensor configured to transmit a signal representative of the vibratory motion of the injection molding machine, and means for comparing the signal against a frequency template to determine potential structural damage to the injection molding machine. The sensor may comprise at least one sensor selected from the group consisting of, but not limited to, an accelerometer, a displacement transducer, a velocity transducer, and a force transducer.

### BRIEF DESCRIPTION OF THE DRAWINGS

These and other features and advantages of the present disclosure will be better understood by reading the following detailed description, taken together with the drawings wherein:

FIG. 1 is a block diagram of one embodiment of a system for detecting and/or monitoring the condition of an injection molding machine according to the present disclosure;

FIG. 2 is one embodiment of an illustrative frequency spectrum generated by one embodiment of the detection system according to the present disclosure for an undamaged component and injection molding machine;

FIG. 3 is one embodiment of an illustrate frequency spectrum generated by one embodiment of the detection system according to the present disclosure for a damaged component and injection molding machine; and

FIG. 4 is a flow chart of one embodiment of the method of operation of the detection system according to the present disclosure.

### DETAILED DESCRIPTION OF THE PREFERRED EMBODIMENTS

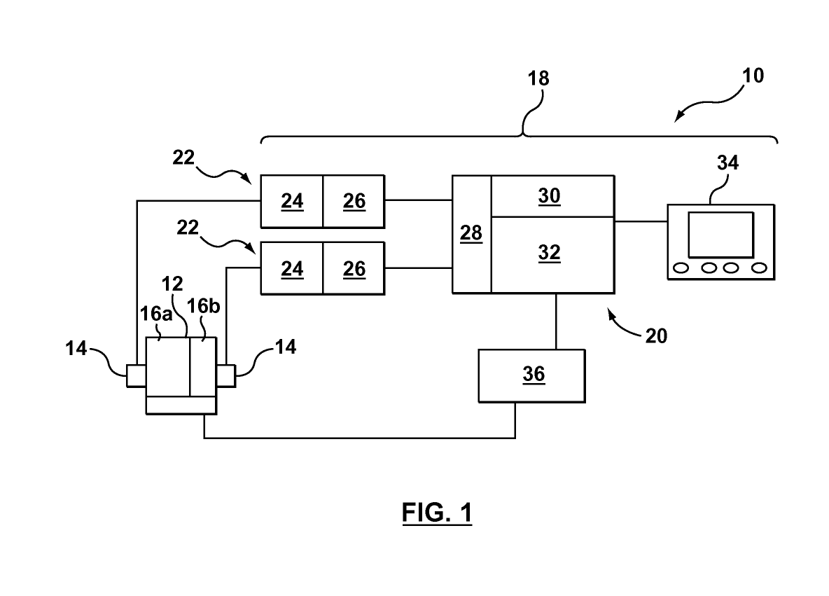

Referring to FIG. 1, one embodiment of a system 10 for detecting and/or monitoring the condition of an injection molding machine 12 according to the present disclosure is shown in schematic block diagram form. One or more sensors 14 may be operatively connected to one or more components 16a, 16b of the injection molding machine 12 to sense vibration, displacement, velocity, force, or acceleration of the components 16. The sensors 14 may include any sensor or transducer design known to those skilled in the art such as, but not limited to, accelerometers (e.g., a micro electro-mechanical system MEMS accelerometer, a quartz piezo-electric accelerometer, or the like), velocity transducers, displacement transducers, force transducers, or the like.

As will be explained in greater detail hereinbelow, the detection system 10 may monitor the natural frequencies or modes of vibration of one or more components 16a, 16b of the injection molding machine 12 to determine the condition of the components 16 and the injection molding machine 12. The sensors 14 may monitor the components 16 and the injection molding machine 12 during the regular operation of the injection molding machine 12 or while not in use (for example, by causing an excitation in the injection molding machine 12 using an outside force). The monitoring may be continuous or periodic, and may be done with varying machine parameters of the injection molding cycle/part/resin/etc. Placement of the sensors 14 may be determined using modal analysis software in conjunction with finite element software to predict the areas or components 16 of the injection molding machine 12 that would be most sensitive to experiencing changes in the vibration due damage (e.g., crack initiation or propagation, the location of which may be determined using the finite element analysis software or experimentally). Additionally (or alternatively), placement of the sensors 14 may be determined through experimentation. For example, while not a limitation, the components 16 which the sensors 14 may be operatively connected to may include a manifold and/or manifold plate, mold cavity plates or inserts, a nozzle (e.g., but not limited, a nozzle tip and a nozzle body), a backing plate, bushings, split sprue bars, an injection unit (such as, but not limited to, a reciprocating screw injection unit), a press, or the like.

During normal operation of the injection molding machine 12, the injection molding machine 12 produces vibrations. These vibrations may be identified and classified as normal modes (also known as natural frequencies or resonant frequencies) and may be used to create frequency templates or patterns representative of a structurally sound component 16 and/or injection molding machine 12. The frequency template may comprise frequency data as a function of machine cycle over various operating ranges (such as, but not limited to, during the clamp phase, during the injection phase, during the hold phase, during the ejection phase, or the like), an entire operating cycle for the manufacture of a part, or while the injection molding machine is not in use as well as various frequency ranges. Alternatively, the frequency template may comprise frequency versus magnitude (amplitude) over various frequency ranges. Any changes to the structural integrity of the injection molding machine 12 will result in changes in the response spectrum of the injection molding machine 12 when observed in the frequency domain.

Each sensor 14 may be operatively connected to a computer system 18 (for example, by wire or wirelessly) which may comprise a processor 20 and one or more signal conditioners 22. The signal conditioners 22 may include an amplifier (such as, but not limited to, a frequency to voltage converter, current to voltage converter, or the like) 24 for amplifying the signal produced by the sensor 14 and one or more filters 26 for filtering the signal. The amplified/filtered signal may then be feed to a converter 28 (e.g., an analog to digital converter) to facilitate processing by the processor 20. Of course, the signal conditioners 22 may also be an integral part of the sensors 14.

The processor 20 may include all of the necessary elements for processing the digital signals including, but not limited to, memory 30 and program software 32. For example, the processor 20 may receive a digitized signal from the signal conditioners 22 representing a physical parameter such as displacement, velocity, or acceleration detected by the sensors 14. The program software 32 may differentiate the digitized signals with respect to time to determine the acceleration (for example, as a function of time which may be normalized), and may store the sensor data (either temporarily or permanently) in the memory 30. A Fast Fourier Transform (FFT) and/or a Discrete Fourier Transform (DFT) may also be used. The processor 20 may utilize the FFT and/or the DFT (as well as any other method known to those skilled in the art for frequency domain conversions and analysis) to convert the data from the time domain to the frequency domain. Additionally (or alternatively), the processor 20 may analyze the signal data in the time domain with by utilizing a time domain window of acceptable operation, similar to the frequency domain window of operation. For example, a time domain template may be utilized in which the sensor signal must be inside of the time domain template at each specific point in the operation cycle to avoid triggering an alarm.

The program software 32 may compare the received digitized signals against a frequency pattern or template stored in the memory 30 (which may have any appropriate units, may be unitless, and/or may be normalized). Acceptable frequency domain operation window values may be generated and stored in the memory 30 representing upper and/or lower limits for certain frequency bands in the template. For example the acceptable frequency domain operation window values may disregard certain frequency peaks below and/or above a specific range or value. The acceptable frequency domain operation window values may include parameters that monitor discrete frequencies, frequency bands, the magnitude of the response, the phase of the response, the power contained within various frequency bands, and the width of the frequency peaks (representing the damping of the system at these frequencies), as well as other parameters. Software may be used to determine the acceptable frequency domain operation window values or they may be determined experimentally. Any changes to the structural dynamics of the injection molding machine 12 will result in changes in the response spectrum of the injection molding machine 12. For example, changes in the structural integrity of a component 16 of the injection molding machine 12 may result in amplification of certain frequency peaks, amplitude variations, changes in the damping characteristics, the shifting of the fundamental mode (i.e., the first resonant frequency), shifting of higher order modes (those above the fundamental mode), the introduction of a new frequency mode of vibration that did not exist prior to the damage of the component or components 16, and/or a relative change in the phase angle of the numerous vibration modes.

The program software 32 may also compare the ratio of one sensor signal coupled to a first component 16a to another sensor signal coupled to another component 16b (transfer function, transmissibility, etc.). As one component 16a of the injection molding machine 12 changes its dynamics, this ratio may change. This approach may reduce the number of “false positives,” as changes which are system wide may not show up as significantly in the ratio. For example, if a pump turns on, the response spectrum may change significantly. However, the response of different components 16 within the injection molding machine 12 may both have changes, and thus if the changes are similar enough in the two components 16, the ratio of the signals may not change significantly enough to trigger an alarm, whereas the output of a single measurement may have changed significantly enough to generate an alarm.

By monitoring these parameters of the injection molding machine 12 and comparing the parameters against the frequency templates, any changes in the structural integrity of the components 16 and injection molding machine 12 may be detected by the program software 32 and used to initiate further investigation or action. Whenever a received digitized signal exceeds an acceptable frequency domain operation window value or is outside a specified range, the program software 32 may output an alarm signal representing potential damage or other problems (such as, but not limited to, loose fasteners or components) relating to a component 16 or the injection molding machine 12.

The program software 32 may also identify the particular component 16 that is potentially damaged and/or classify the potential failure (for example, but not limited to, based on the comparison between the frequency template and any known component failure frequency data which may also be stored in the memory 30). According to one embodiment, the program software 32 may classify the potential damage to the injection molding machine 12 in terms of severity of the potential damage (e.g., minor or catastrophic), the likely time or number of cycles remaining before catastrophic failure, or the like. Additionally, damage to specific components 16 may result in identifiable frequency or amplitude changes (which may be determined either experimentally or by finite element analysis).

The output of the processor 20 may be sent to a display 34 (for providing a status indicator of the injection molding machine 12), an injection molding machine controller 36, and/or a visual, auditory, or vibratory indicator (not shown). Upon determination of potential damage to the injection molding machine 12, the processor 20 may output an alarm condition. The alarm condition may trigger an alarm warning on the display 34 and/or may trigger the injection molding machine controller 36 to take corrective action which may include taking any necessary action to reduce or prevent further damage to the injection molding machine 12 (for example, disabling the injection molding machine 12 or the like in the event of a high priority alarm condition) or scheduling a maintenance event in the future (for example, in the event of a low priority alarm condition).

For example, a low priority classification may be used for conditions when something has changed significantly enough to cause operation outside of the acceptable window, though the exact cause may not be known. On the other hand, a high priority condition may (for example) include a condition which is understood well enough that the software may determine the source of the change (for example, but not limited to, a crack beginning in the lower operator side corner of the manifold, drop xx, or the like). This knowledge may be obtained through experimentation. Lack of this knowledge in this regard, however, does not limit the capabilities of the system in terms of noticing changes, though it may make the determining the exact cause of the change more difficult.

Because the detection system 10 according to one embodiment of the present disclosure may utilize frequency and/or time domain analysis to determine the condition of the injection molding machine 12, the detection system 10 may be able to identify changes in the structural integrity of the components 16 and the injection molding machine 12 prior to more server damage leading to catastrophic failure, degradation of plastic part quality, resin leaking or exiting the component 16, or other problems. For example, the detection system 10 according to one embodiment may be able to detect a crack in a manifold of the injection molding machine 12 prior to the resin exiting the manifold. The ability to detect possible damage to the injection molding machine 12 prior to catastrophic component failure and/or an actual leak occurring has numerous benefits.

For example, appropriate action may be taken (such as shutting down the injection molding machine 12) prior to catastrophic failure and/or prior to the internal voids of the injection molding machine 12 becoming contaminated with resin. The ability to take corrective action earlier may not only increase the overall safety of the injection molding machine 12, but may also reduce operating costs associated with the injection molding machine 12. For instance, it may be possible to repair a damaged component 16 rather than replacing it if the damage to the component 16 can be detected early enough. Even if a leak from a component 16 of the injection molding machine 12 is detected immediately upon resin exiting the component 16, it may not be feasible to prevent the resin from continuing to escape from injection molding machine 12 given the pressure, temperature, and physical restraints of an injection molding machine 12. Consequently, it may be possible to prevent damage to components 16 (e.g., heater bands, wires, sensors, actuators, terminals, insulation, and the like) proximate the damaged component 16 if the damage to the component 16 can be detected before the resin exits the damaged component 16. Additionally, detecting damage of a single component and taking the appropriate action may prevent continued damage to this component and/or other components in the system. Moreover, the amount of downtime and labor to repair the injection molding machine 12 may be reduced and it may be possible to identify possible damage to the injection molding machine 12 and schedule maintenance/repair of the damaged component 16 during a time period when the injection molding machine 12 is not being used.

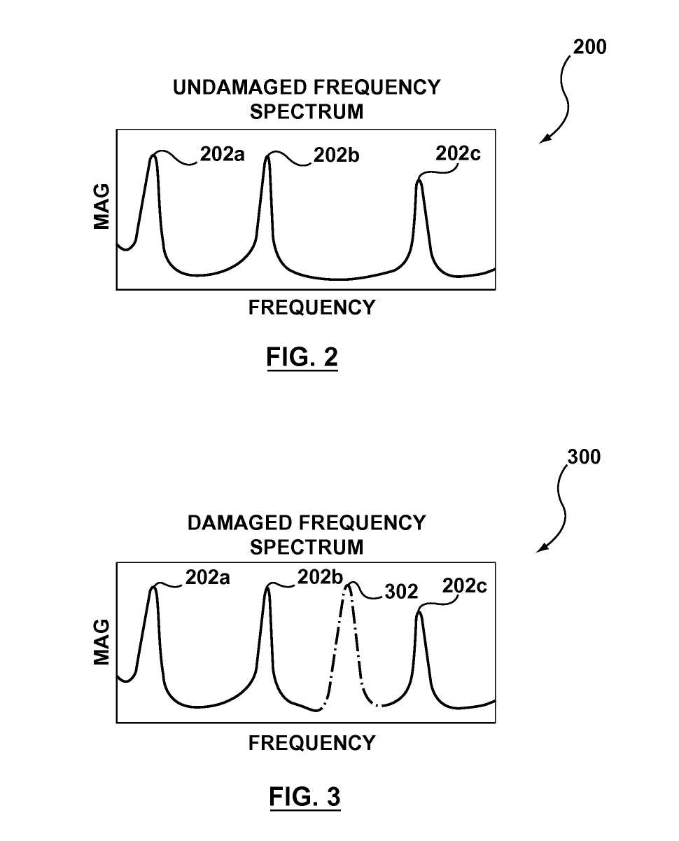

Referring specifically to FIG. 2, one embodiment of an illustrative frequency spectrum 200 generated by the detection system 10 is shown for an undamaged component 16 and/or injection molding machine 12 according to the present disclosure. As can be seen, the frequency spectrum 200 may include a plurality of frequency peaks 202a-c occurring at various frequencies within a frequency range. These frequency peaks 202a-c may be used to generate the frequency template as discussed above.

In contrast, one embodiment of an illustrate frequency spectrum 300 generated by the detection system 10 is shown in FIG. 3 for a damaged component 16 and/or injection molding machine 12. As can be seen, the expected frequency peaks 202a-c are present. However, an additional frequency peak 302 can now be seen between frequency peaks 202b and 202c. This additional frequency peak 302 may indicate additional vibration modes that may, for example, be caused by a cracked or damaged component 16. While the magnitude of the additionally frequency peak 302 is shown substantially equal to the expected frequency peaks 202a-c, this is not a limitation of the present disclosure. As discussed above, acceptable frequency domain operation window values may be set above and below which frequency peaks may be ignored or disregarded. Additionally, the detection system 10 may feature a graduated or tiered system wherein various peaks may be noted and classified for investigation. It is important to note that frequency spectrums represented in FIGS. 2 and 3 are for provided for illustrative purposes only and are not a limitation of the present disclosure unless specifically claimed as such.

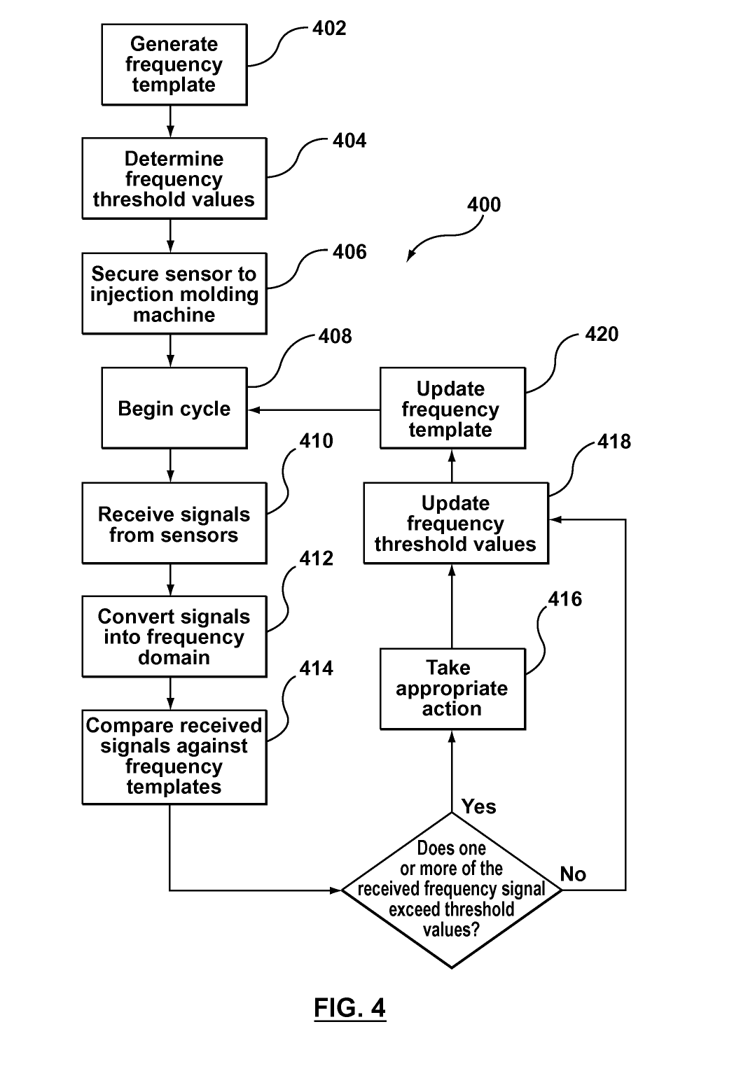

Referring to FIG. 4, a flow chart illustrating one embodiment of the method 400 of operating the detection system 10 according to the present disclosure is shown. A frequency template may be generated, act 402, and acceptable frequency domain operation window values (for example upper and/or lower values, both in terms of frequency and/or magnitude) may be generated, act 404, and stored in memory 30. One or more sensors 14 may be secured or otherwise coupled to one or more components 16 of an injection molding machine 12, act 406.

Once the sensors 14 are secured, the detection system 10 is ready to begin the detection cycle, act 408, and the sensors 14 may transmit signals that may be received (either across wires or wirelessly) by the computer system 18, act 410. It should be noted that the detection cycle may include an entire operating cycle of the injection molding machine 12, a portion of the operating cycle of the injection molding machine 12, or when the injection molding machine 12 is not in use (for example, while an external excitation is introduced into the injection molding machine 12). The external vibration may include any method known to those skilled in the art including, but not limited to, broadband/random, sine sweep, sine chirp, impact, or the like.

The signals received from the sensors 14 may then be converted to generate a frequency spectrum, act 412. For example, the signals may be filtered, amplified, and converted from analogue signals to digital signals. The resulting signals may then be compared against the stored frequency template, act 414. If the received signals exceed the acceptable frequency domain operation window values, appropriate action may be taken, act 416. For example, an alarm may be generated, the injection molding machine 12 may be shut down, an operator of the injection molding machine 12 may be notified, and/or a maintenance event may be scheduled for the injection molding machine 12. In any case, the acceptable frequency domain operation window values may optionally be updated, act 418, and the frequency template may also be optionally updated, act 420, in view of the received sensor data. The ability to update may allow the system to self-tune itself and may feature a learning algorithm to prevent false alarms while also becoming more sensitive to changes that are indicative of some sort of failure. Numerous templates and acceptable frequency domain operation window values may be employed simultaneously to monitor various types of changes in the structural dynamics of the system. For example, the monitoring system may be used to monitor long term changes (for example, but not limited to, years or even the entire life of the injection molding machine), short term changes (for example, but not limited to, cycle to cycle, day to day, month to month, etc.), or changes due to other parameters (such as, but not limited to, machine parameters, resin types, temperature, or the like).

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A detection system comprising:
a component of an injection molding machine;
a sensor operatively coupled to said component of said injection molding machine, said sensor configured to transmit a signal representative of a movement of at least said component of said injection molding machine; and
a processor configured to convert said signal into a frequency domain signal and to determine changes in structural dynamics of said injection molding machine indicative of structural damage to said injection molding machine.

2. The detection system of claim 1 wherein said sensor comprises an accelerometer.

3. The detection system of claim 1 wherein said sensor comprises a displacement transducer.

4. The detection system of claim 1 wherein said sensor comprises a velocity transducer.

5. The detection system of claim 1 wherein said sensor comprises a force transducer.

6. The detection system of claim 1 wherein said processor further comprises memory for storing a frequency template, wherein said processor is further configured to compare said frequency domain signal against said frequency template to determine said structural integrity of said injection molding machine.

7. The detection system of claim 6 wherein said memory further comprises frequency domain operation window values for a magnitude of said structural response signals as a function of frequency over an entire spectrum of interest, wherein said processor is configured to disregard values that fall outside said frequency domain operation window values.

8. The detection system of claim 1 further comprising:
a signal conditioner configured to convert said signal from said sensor;
an amplifier configured to amplify said signal transmitted by said sensor;
a filter configured to filter said signal transmitted by said sensor; and
an analog-to-digital converter configured to convert said signal from an analog signal to a digital signal, wherein said digital signal is transmitted to said processor.

9. The detection system of claim 1 wherein said component comprises a manifold.

10. The detection system of claim 1 wherein said component comprises a mold.

11. The detection system of claim 1 wherein said component comprises a nozzle.

12. The detection system of claim 1 wherein said component comprises a backing plate.

13. The detection system of claim 1 wherein said component comprises a bushing.

14. The detection system of claim 1 wherein said component comprises a sprue bar.

15. The detection system of claim 1 wherein said component comprises an injection unit.

16. The detection system of claim 1 wherein said component comprises a manifold plate.

17. The detection system of claim 1 wherein a source of said movement of at least said component of said injection molding machine comprises a normal operation of said injection molding machine.

18. The detection system of claim 1 wherein a source of said movement of at least said component of said injection molding machine comprises a force external to said injection molding machine.

19. A method of evaluating a structural integrity of an injection molding machine comprising:
generating a signal representative of a movement of at least one component of said injection molding machine; and
analyzing said signal to determine changes in structural dynamics of said injection molding machine indicative of structural damage to said injection molding machine.

20. The method of claim 19 wherein said step of generating said signal further comprises receiving a signal from an accelerometer sensor operatively coupled to said at least one component of said injection molding machine.

21. The method of claim 19 wherein said step of generating said signal further comprises receiving a signal from a displacement transducer operatively coupled to said at least one component of said injection molding machine.

22. The method of claim 19 wherein said step of generating said signal further comprises receiving a signal from a velocity transducer operatively coupled to said at least one component of said injection molding machine.

23. The method of claim 19 wherein said step of generating said signal further comprises receiving a signal from a force transducer operatively coupled to said at least one component of said injection molding machine.

24. The method of claim 19 wherein said step of generating said frequency domain signal further comprises:
amplifying a signal generated by a sensor operatively coupled to said at least one component of said injection molding machine;
filtering said signal; and
converting said signal from an analog signal into a digital signal.

25. The method of claim 19 further comprising generating an alarm condition representative of a possible structural damage to said injection molding machine.

26. The method of claim 25 wherein said act of generating said alarm condition further comprises notifying an operator of said injection molding machine.

27. The method of claim 25 wherein said act of generating said alarm condition further comprises transmitting an alarm signal to an injection molding machine controller.

28. The method of claim 25 wherein said act of generating said alarm condition further comprises classifying said alarm condition as either a low priority condition or a high priority condition.

29. The method of claim 28 further comprising:
automatically scheduling a maintenance event corresponding to a low priority condition; and
automatically shutting down said injection molding machine corresponding to a high priority condition.

30. The method of claim 19 wherein said act of analyzing said signal to determine changes in structural dynamics of said injection molding machine further comprises comparing said signal against a frequency template.

31. The method of claim 19 further comprising applying an external force to said injection molding machine to generate said movement of at least one component of said injection molding.

32. The method of claim 19 further comprising generating said signal representative of said movement of at least one component of said injection molding machine during a normal operation of said injection molding machine.

33. A detection system comprising:
a sensor configured to transmit a signal representative of a movement of at least one component of said injection molding machine; and
a processor configured to analyze said signal and to determine changes in structural dynamics of said injection molding machine indicative of structural damage to said injection molding machine.

34. The detection system of claim 33 wherein said sensor comprises at least one sensor selected from the group consisting of an accelerometer, a displacement transducer, a velocity transducer, and a force transducer.

35. The detection system of claim 33 further comprising at two sensors configured to transmit a first and a second signal representative of a movement of a first and a seconds component of said injection molding machine, wherein said processor compares a ratio of said first and said second signals to determine changes in structural dynamics of said injection molding machine indicative of structural damage to said injection molding machine.
